(19) United States
(12) Patent Application Publication
(10) Pub. No.: US 2012/0206301 A1
(43) Pub. Date: Aug. 16, 2012

(54) MULTI-ANGLE ULTRA WIDEBAND ANTENNA WITH SURFACE MOUNT TECHNOLOGY METHODS OF ASSEMBLY AND KITS THEREFOR

(75) Inventors: Javier Ruben Flores-Cuadras, Tijuana (MX); Ronan Quinlan, Taoyuan City (TW); Dermot O'Shea, La Jolla, CA (US)

(73) Assignee: Taoglas Group Holdings, La Jolla, CA (US)

(21) Appl. No.: 13/399,044

(22) Filed: Feb. 17, 2012

Related U.S. Application Data
(63) Continuation-in-part of application No. 12/566,199, filed on Sep. 24, 2009.

(51) Int. Cl. H01Q 1/38; H01P 11/00

(52) U.S. Cl. 343/700 MS; 29/600

(57) ABSTRACT

The disclosure provides a multi-angle flexible antenna for electronic device comprising an antenna expand having the radiated elements supported by a first substrate and expanding into a spatial geometry for transmission and reception of radio signal; and an antenna base having a plurality of first solder pads on a second substrate for physical attachment to the printed circuit board and a second solder pad electrically connected to a terminal of the radiated elements for connection to an antenna feed point of a radio circuitry on the printed circuit board; wherein the first and second substrates are joined at a bending line as a single substrate for the flexible antenna and the first substrate allowed to be bent relative to the plane of the second substrate for spatial deployment of the radiated elements.

### CROSS-REFERENCE

This application is a continuation-in-part application of Ser. No. 12/566,199, filed Sep. 24, 2009, which is incorporated herein by reference in its entirety and to which application we claim priority under 35 USC §120; and claims the benefit of U.S. Provisional Application No. 61/448,860 filed on Mar. 3, 2011, which is incorporated herein by reference

### FIELD OF THE INVENTION

The present invention relates in general to antennas, in particular to surface mount devices, and more particularly an antenna with a flexible body that can be bent across a plane at different angles and can be directly assembled to a printed circuit board by surface mount techniques. More particularly, the present invention relates to a multi-angle ultra wideband antenna with surface mount technology for wireless applications such as Global Solutions for Mobile Communications (GSM), Long Term Evolution (LTE), Wi-Fi™, wireless high definition television (HDTV), Bluetooth, Public Safety, radio frequency identification (RFID), worldwide interoperability for microwave access (WIMAX), tolling, remote control, tracking assets, and unlicensed band wireless applications. The invention is suitable for use in any wireless application which uses 100 MHz to 18 GHz.

### BACKGROUND OF THE INVENTION

Extensive efforts have been devoted to research and develop an antenna that can be used throughout the world, covering all the current cellular bands and complying with all communication standards, plus having the convenient surface mount technique for low cost and high reliability.

Cellular and mobile devices are now operating with quad-band antennas, these bands include the 850 MHz global systems for mobile communications (GSM), 900 MHz extended global systems for mobile communications (EGSM), 1800 MHz digital communication system (DCS) and 1900 MHz personal communication system (PCS). With the introduction of 3G and 4G technologies for higher speed and data transfer rate in cellular applications, four new bands have been introduced in the radiofrequency spectrum, 700 MHz long term evolution (LTE) 3GPP 4G technology, 1700 MHz universal mobile telecommunications system (UMTS) and the 2100 MHz (WCDMA) and the 2600 MHz Long Term Evolution 3GP 4G Technology.

With the introduction of the new 700 MHz LTE band in North America, it is indeed higher complexity for its integration while keeping the antenna size similar to quad-band antenna, satisfying the current demands for small devices. Over the years is observed how the devices tend to be smaller, but with the new low frequency band presents a real challenge in miniaturization and the bandwidth must be increased to incorporate more new frequencies: 1710 MHz and 2100 MHz bands. New technologies, materials, topologies, form factors and novel designs must be studied to continue miniaturizing the antennas and complains with the demands of the current and future market's needs.

The basic formula for antenna design dictates that the length of the antenna is one-quarter of the wavelength at the desired frequency, 35 mm (one quarter of the wavelength in free space) is the physical length for a pure straight cable or, monopole antenna at 2100 MHz, contrasting with 108 mm of physical length for a basic monopole antenna at 700 MHz. Reducing the antenna at low frequencies present a real challenge, but some techniques are studied like increasing the dielectric constant of the material that enclose the antenna, bending the metallic radiated element and find the specific geometrical shape that reduce the space occupied by the antenna. The ratio of miniaturizing and antenna via higher dielectric constant is equal to 1/√ε, where ε is the dielectric constant of the material used as a carrier for the metallic path of the antenna.

### SUMMARY OF THE INVENTION

An aspect of the disclosure is directed to an ultra wideband antenna to cover all the cellular bands worldwide, operating as a hepta-band cellular antenna, enclosing the traditional quad-band cellular antenna and the three new bands.

Another aspect of the disclosure provides an antenna with sufficient gain, efficiency, bandwidth and omni-directional properties to be used in other bands such as 2300, 2400 and 2500 MHz used in Wi-Fi™, WiMAX, ISM, ZigBee and emerging technologies in the frequencies from 100 MHz to 18 GHz.

Still another aspect of the disclosure provides a multi-angle flexible antenna for electronic device comprising an antenna expand having the radiated elements supported by a first substrate and expanding into a spatial geometry for transmission and reception of radio signal; and an antenna base having a plurality of first solder pads on an antenna base substrate for physical attachment to a printed circuit board, a second solder pad electrically connected to a terminal of the antenna conductor for connection to an antenna feed point of a radio circuit on the printed circuit board, and one or more apertures positioned along at least a portion of a perimeter of the second solder pad; wherein the expandable antenna substrate and antenna base substrates are positioned in a first plane and a second plane positioned at one or more angles from −90 to +90 degrees from the first plane.

Yet another aspect of the disclosure provides an antenna with a flexible body, where the first substrate can be bent at different angles about an axis from −90 to +90 degrees with respect to the second substrate. As will be appreciated by those skilled in the art, other angles could be used without departing from the scope of the disclosure. For example, an angle from −135 to −90 and from +90 to +135 could be used with respect to the second substrate, however the overall performance of the antenna may not be the same as antennas that range from −90 to +90. Stiffening or shape memory can be added to maintain the position in a certain angle. The second stiffening component can be, for example, ABS or PVC. Other materials can be used without departing from the scope of the disclosure. The second stiffening component is configurable to operation as a configuration control component adapted and configured to return the device to a configuration or maintain the device in a configuration.

The present disclosure achieves the above and other aspects by providing a flexible antenna for electronic devices, that can simplify the assembling process in the antenna integration, incorporating the surface mount device technology in the antenna structure to a printed circuit board on the second substrate of the antenna onto the printed circuit board, having a plurality of first solder for physical attachment and a second solder pad electrically connected onto the printed circuit board for the radio signal propagation. The flexible material is not deformed by the high temperatures in the surface mount process and/or not suffering any kind of shrinking effect in the substrate.

Suitable flexible material, such as material formed from polymerizing an aromatic dinahydride and an aromatic diamine, commercially available as Kapton®, can be used on antennas prepared according to this disclosure. The flexible material, such as Kapton®, has a dielectric constant of 3.8. The total thickness of the flexible material ranges from 0.01 mm to 1.00 mm, and is approximately 0.085 mm in many configurations. The flexible material encloses the radiated elements. Using this flexible material for the antenna design facilitates enclosing radiated elements with the flexible material, thus reducing the size of the antenna even with a thin form factor. Additionally, as the electromagnetic field current travels on the surface of the radiated elements and interacts with the high dielectric constant material, the thin material with high dielectric constant supports the radiated elements. Thus, it is almost imperceptible in compare with the air that surrounds the antenna which means the antenna is surrounded mainly by air, resulting in an effective dielectric constant (computation the two materials with different dielectric constant) very close to the free-space.

A stiffening component can be incorporated to assist a successful surface mounting assembly procedure of the antenna to the device, it can be made by any Flame Retardant 4 (FR-4) material or the UL-94-VO standard polyimide attaching it to the antenna with a very fine glue or adhesive material. This glue can afford the high temperature for the surface mounting device (SMD) process. This stiffening component can be easily removed after the surface mount process when is concluded without leave any residue. Due the light in weight of the antenna could not be accurate to stay on its placed location on the device and/or too thin in thickness to maintain its proper structural shape during the entire procedure as consequence from violent pick-and-place movements for all components of the device-board. Usefulness of such as stiffening component is to provide overall structural rigidity and add weight to the flexible antenna to maintain the placement in the SMD production, having an extra in weight pressing down the antenna and having a better contact, avoiding inaccurate soldering.

A low profile flexible antenna in accordance with the present disclosure is based essentially on flexible circuit technology that is particularly useful when applied to mobile applications such as for consumer electronic devices, having a unique characteristic where in one structure high performance, surface mountable and having different bending angles to conform different shapes are achieved, ending in easy, practical, cheap and time saving at the integration. Automated integration becomes possible avoiding labors such as soldering and installation of pogo pin and spring contacts, resulting in a reliable and consistence antenna performance and the present invention can be delivered on tapes and reels just like SMD diodes, resistors and others.

The complete surface mount technology integration provided for enables an easy, cheap, time saving, and automated integration which eliminates the necessity of human interactions for soldering purposes, pogo pin and spring contacts. All of this assembling and integration qualities ends in delivering a reliable and consistence antenna performance, reflected on better signal reception, making the antenna feasible for telematic, tracking, telemedicine, automotive, fleet management, vehicle diagnostics, remote monitoring and also in the emerging telemedicine diagnostic market.

The antennas disclosed achieve a compact volume, with a minimum footprint and can be placed into the housing of the mobile device. Antennas can also be mounted directly on edge of device main-board. Transmission losses can be kept at a minimum resulting in much improved over the air (OTA) device performance compared to similar efficiency cable and connector antenna solutions. Moreover, there is a reduction in backward radiation toward the user's head compared to other antenna technologies, thus minimizing the electromagnetic wave power absorption (SAR) which in turn enhances the antenna's performance. The antennas achieve a moderate to high gain in both vertical and horizontal polarization planes. This feature is very useful in certain wireless communications where the antenna orientation is not fixed and the reflections or multipath signals may be present from any plane. In those cases the important parameter to be considered is the total field strength, which is the vector sum of the signal from the horizontal and vertical polarization planes at any instant in time. The antennas are configured to use labour saving SMT which facilitates a higher quality yield rate and eliminates antenna tooling costs.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 is a plan view of portion of a multi-angle ultra wideband antenna with surface mount technology;

FIG. 2a illustrates the multi-angle ultra wideband antenna showing an expanded section at a +90 degree position relative to the plane of the antenna base; FIG. 2b illustrates a board with holes or apertures forming a fence around select areas to achieve an improved shielding of the system; FIG. 2c illustrates exposed metal layers of a board; FIG. 2d illustrates the metal layer and the antenna layer of an antenna; FIG. 2e illustrates the metal layer and the solder area;

FIG. 3 is a sectional view to describe the different layers in the flexible antenna taken along the lines A-A shown in FIG. 1;

FIG. 4 is a perspective view with 0 degrees position on a typical automobile vehicle locator device;

FIG. 5 is a perspective view with −90 degrees position on a typical automobile vehicle locator device;

FIG. 6a is a graph that illustrates a return loss graph; FIG. 6b is a graph that illustrates the voltage standing wave ratio (VSWR) data for an antenna;

FIG. 7 is a graph that illustrates gain data;

FIG. 8 is a graph that illustrates radiation efficiency data; and

FIGS. 9a-g illustrate radiation patterns from −18 to 6 dB in the 700 mHz band (FIG. 9a); 850 mHz band (FIG. 9b); 950 mHz band (FIG. 9c); 1700 mHz band (FIG. 9d); 1800 mHz band (FIG. 9e); 1900 mHz band (FIG. 9f); 2100 mHz band (FIG. 9g).

### DETAILED DESCRIPTION OF THE INVENTION

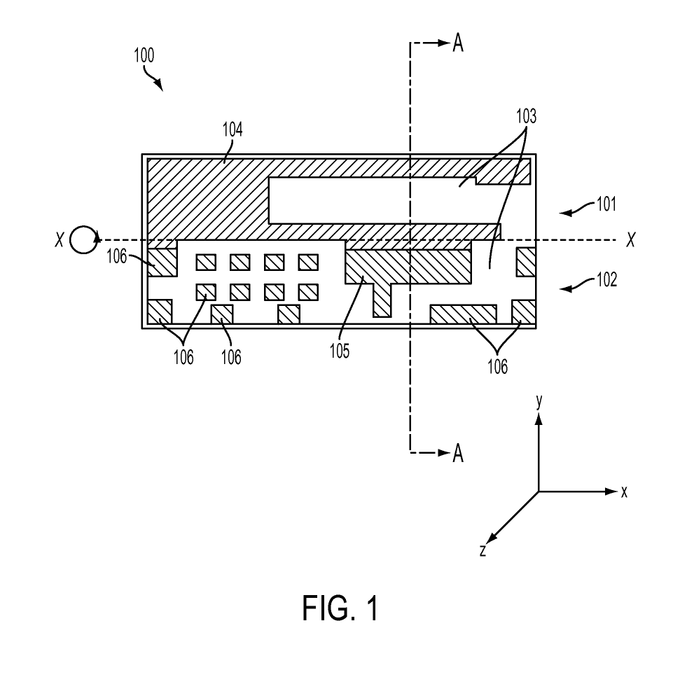

In an embodiment of the disclosure a flexible antenna is essentially an electrical component much like a multi-lead integrated chip (IC) or other surface mountable electronic components and is treated like one. FIG. 1 illustrates an ultra wide band antenna 100 capable of operating in, for example, up to eight cellular bands with no cable required for signal radio propagation in accordance with an embodiment of the present disclosure. The antenna 100 is depicted lying within a plane (x-z).

The flexible antenna 100 has an exposed metal layer 104 patterned into a desired shape and geometry. An upper side of the antenna component 100 faces toward a printed circuit board when it is assembled. This metallic pattern with its specific spatial geometry is typically shaped from half-ounce copper layer adhered to a substrate. Metal layer 104 is held in a fixed shape and position by any suitable thin insulator substrate 103. As will be appreciated by those skilled in the art, the metal layer 104 which is conductive can be formed from any suitable conductive metal, including, but not limited to copper, aluminum, nickel, silver, and chrome. The insulation layer 103 may also be configured such that it has exposes portions of the metal layer 104.

As illustrated in FIG. 1 the ultra wideband antenna 100 can be divided into two portions by a bending line (shown as phantom line x in the drawing), i.e., an antenna expand section 101 and an antenna base section 102. The antenna expanded section 101 and the antenna base section 102 can be formed integrally with, for example, a scored line that facilitates a weakened area along an axis about which the expanded section 101 can be bent. Alternatively the expanded section 101 and the base section 102 can be formed from two pieces that are joined together. The antenna expand 101 is an expansion of the flexible antenna conductor with its designed shape and spatial geometry. This portion of the flexible antenna 100 is allowed to bend away from a plane of the antenna base 102 (bending around the axis x either in an upward direction up to at least 90 degrees or in a downward direction up to at least 90 degrees, i.e., from a flat position within the x-z plane into the x-y plane), permitting adjustment of the antenna conductor deployment relative to the main board or printed circuit board (PCB) of the electronic device that the antenna serves from −90 to 90 degrees. With greater angles, the antenna may not operate as described. However, as will be appreciated by those skilled in the art, other ranges can be used including from −135 to +135 and, ranges therein. A second stiffening member or component can be added to maintain the position of the angle. Suitable stiffening components include components configured from ABS or PVC or any other suitable material selected. The second stiffening component is configurable to operation as a configuration control component adapted and configured to return the device to a configuration or maintain the device in a configuration.

Antenna base 102 is used for both the physical and electrical connection of the entire antenna 100 to the PCB, on which it is to be assembled using a surface mount technique. As illustrated, several solder pads 106 are positioned on a bottom side of the antenna, where the bottom side is positioned to facilitate physically attaching the entire antenna 100 to a host printed circuit board when assembled in a surface mounting procedure. Another solder pad 105, which is electrically connected to the lead terminal of the antenna, serves to electrically connect the antenna to a corresponding antenna feed point of the radio circuitry located on the printed circuit board, both pads serves to physically attached the antenna. To electrically connect the antenna gold plated connectors can be used to avoid oxidation after production. This provides a clean and reliable mounting procedure once the antenna is fixed to its host printed circuit board.

While the antenna metal layer 104 and the solder pads 105 are seen formed on the bottom side of the flexible antenna 100, they are still visible through the partially opaque insulation substrate 103 from the top side, as is illustrated in FIG. 1.

The antenna shown in FIG. 1 can also be dimensionally configurable by changing the angle of the first substrate and the surface mountable UWB (ultra wide band) antenna for consumer electronics. Radiating element of the UWB antenna, the metal layer 104 which may be adhered to the insulation material 103, has a designed spatial geometry for optimized performance in the UWB category of antennas. Spatial geometry of the shape of radiation element 104 has complete control over antenna resonance and performance. Once optimized for a design, change in the form and shape of the metal layer 104 pattern may sometimes be necessary for fine-tuning. In this case, a low cost and flexible antenna 100 can be redesigned and replaced with ease.

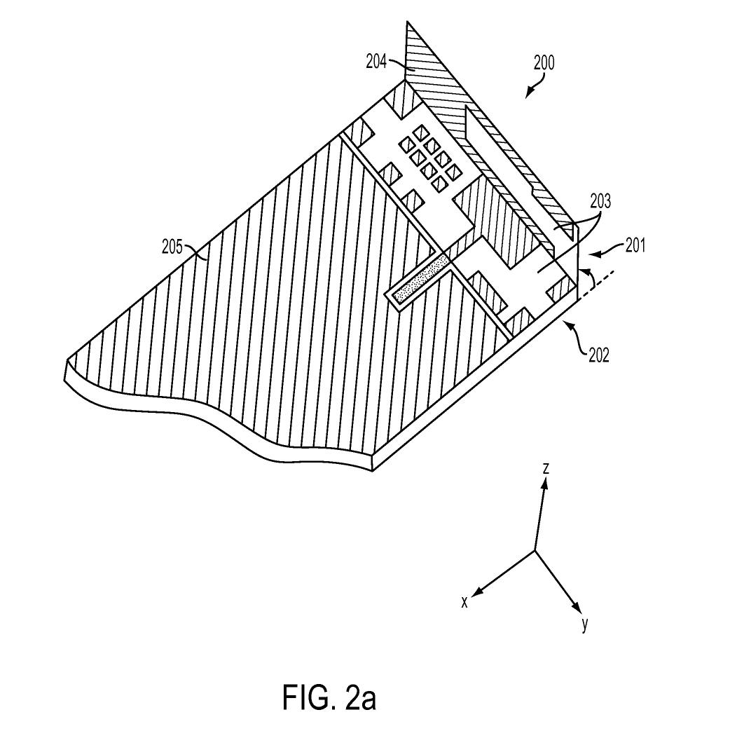

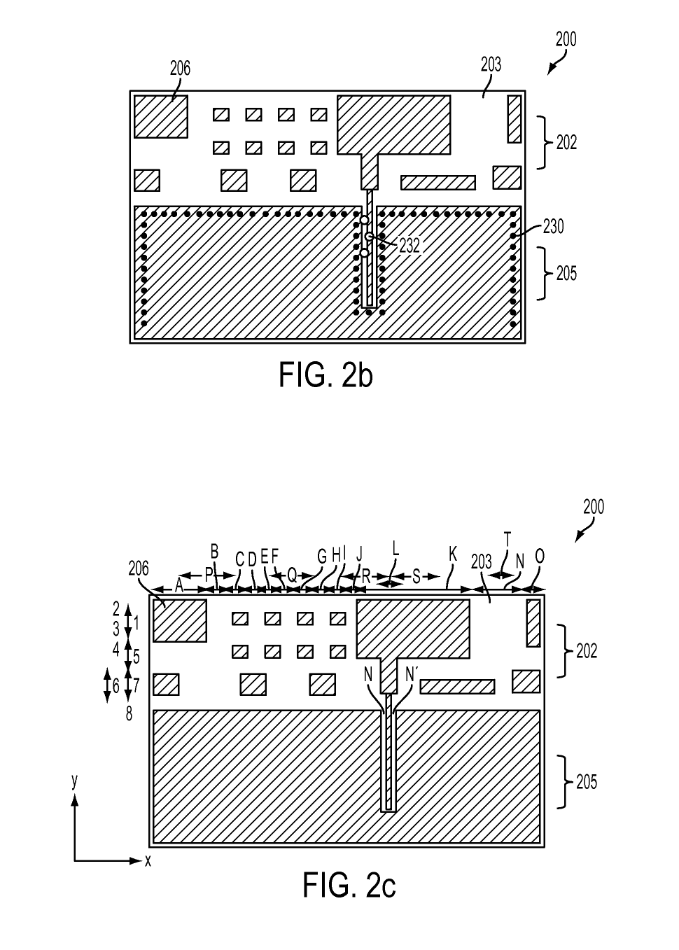

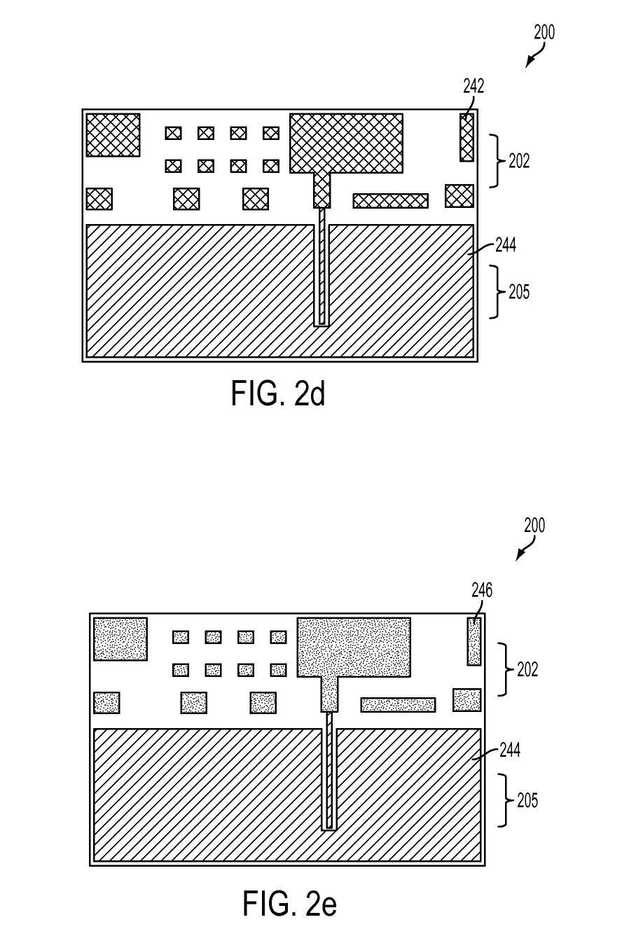

FIG. 2a is a perspective view of a flexible antenna 200 with an up-bending of its antenna expand 201 relative to its antenna base 202. Antenna base 202 is used for both the physical and electrical connection of the entire antenna 200 to the PCB, on which it is to be assembled using a surface mount technique. As illustrated, several solder pads 206 (in FIG. 2B) are positioned on a bottom side of the antenna, where the bottom side is positioned to facilitate physically attaching the entire antenna 200 to a host printed circuit board when assembled in a surface mounting procedure. Another solder pad 205, which is electrically connected to the lead terminal of the antenna, serves to electrically connect the antenna to a corresponding antenna feed point of the radio circuitry located on the printed circuit board, both pads serves to physically attached the antenna. To electrically connect the antenna gold plated connectors can be used to avoid oxidation after production. This provides a clean and reliable mounting procedure once the antenna is fixed to its host printed circuit board.

If necessary, antenna expand 201 of antenna 200 can be configured into different bending angles with respect to the plane of the circuit board 210 (shown in an x-y plane). The antenna expand 201 can be bent around the x-axis, in a wide range from nearly −90 degrees to nearly +90 degrees. This bending permits spatial adjustment of the antenna conductor relative to the main board of the electronic device that the antenna serves when the antenna is deployed. Such bending can be facilitated either before or after the antenna's assembly to the host printed circuit board. The antenna 200 has the insulation material 203, as shown in FIG. 1. The flexible antenna expand 201 enables the antenna to sit at the edge of a device deploying the antenna to take advantage of the ground-plane, if desired, and to connect via a co-planar waveguide to the module. Although not all deployments of the antenna 200 require the antenna to sit at the edge of the device to achieve labor saving, high efficiency. The configurations do enable less expensive tooling, decreased loss of higher radiofrequency (RF) performance, economical, automated SMT process which is also more accurate and higher quality. Moreover, there is no need for a cable connector.

FIG. 2b illustrates a board 210 connected to or formed integrally with the antenna base 202 with one or more holes or apertures 230 forming a fence around select areas to achieve an improved shielding of the system. The use of a fence provides better grounding and optimizes antenna performance. The one or more holes or aperture 230 interconnect the ground planes in between the top, bottom and ground layers. Under some conditions, the board 210 causes detuning of the antenna. To provide a mechanism for addressing detuning issues post production, spaces can be left for a matching network. Spacing 232 enables a pi network in between the GSM module starting at the edge of the ground plane.

FIG. 2c illustrates exposed metal layers 204 of a board 210 in combination with an antenna base 202. The size of the antenna ranges from 50-80 mm along one length and 15-25 mm along a second length, and more typically about 62 mm×18 mm. FIG. 2d illustrates the metal layer 242 for the antenna base 202 in cross-hatch (XX) and the metal layer 244 of the board 210 in hatch lines (/) for a hepta band cellular antenna. FIG. 2e illustrates the metal layer 244 of the board 210, again in hatch lines (/) and the solder area 246 of the antenna base 202 shown as stippled.

This is particularly the case in small and thin flexible antennas that may be too light in weight to stay on its placed location on the PCB and/or too thin in thickness to maintain its proper structural shape during the entire procedure of violent pick-and-place movements for all components of the PCB. Usefulness of such a stiffening component is to both provide overall structural rigidity and add weight to the flexible antenna so that antenna placement in the SMT production stage may enjoy good positioning accuracy.

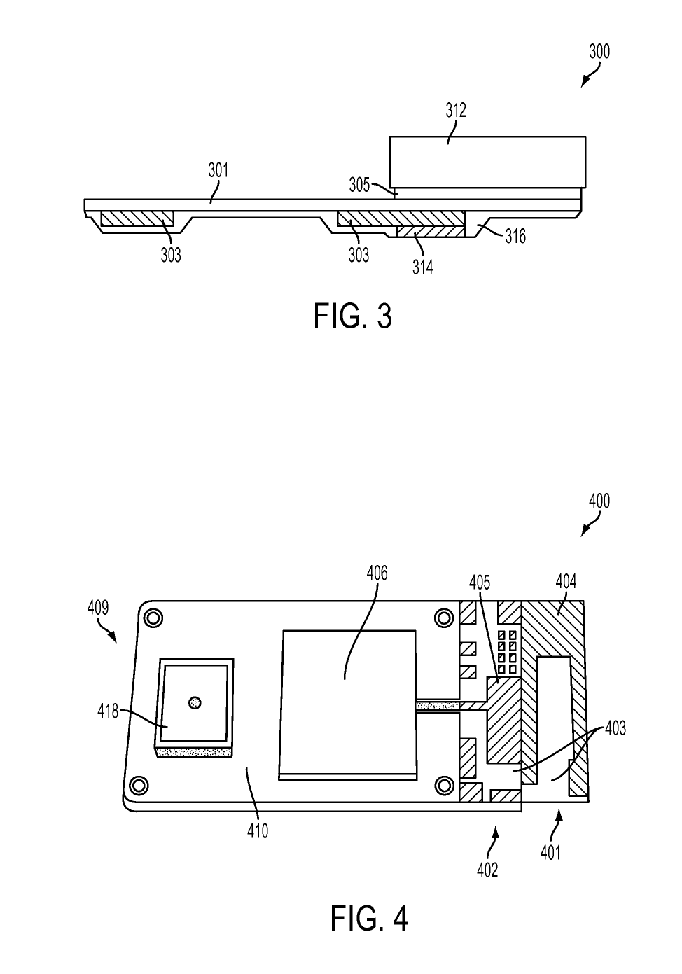

FIG. 3 is the cross-sectional view (not to scale) of ultra wideband antenna of the present disclosure taken along the lines A-A shown in FIG. 1a. The antenna has an upper surface 321 and a lower surface 323 and includes the antenna expansion section 301 and the antenna base 302. A stiffening component 312, which can be made of Flame Retardant 4 (FR-4) material to the UL-94-V0 standard, can be attached to the top surface of the antenna base 302 of the flexible antenna 300 via convenient method, for example the use of a layer of adhesive 314, to peel off of the stiffening component 312 after the antenna is assembled in an IR reflow procedure reduces both size and weight of the finished electronics product deploying the antenna Also, as is well known in the art, a layer of solder mask 316 is typically used to protect the metal 303 of the antenna.

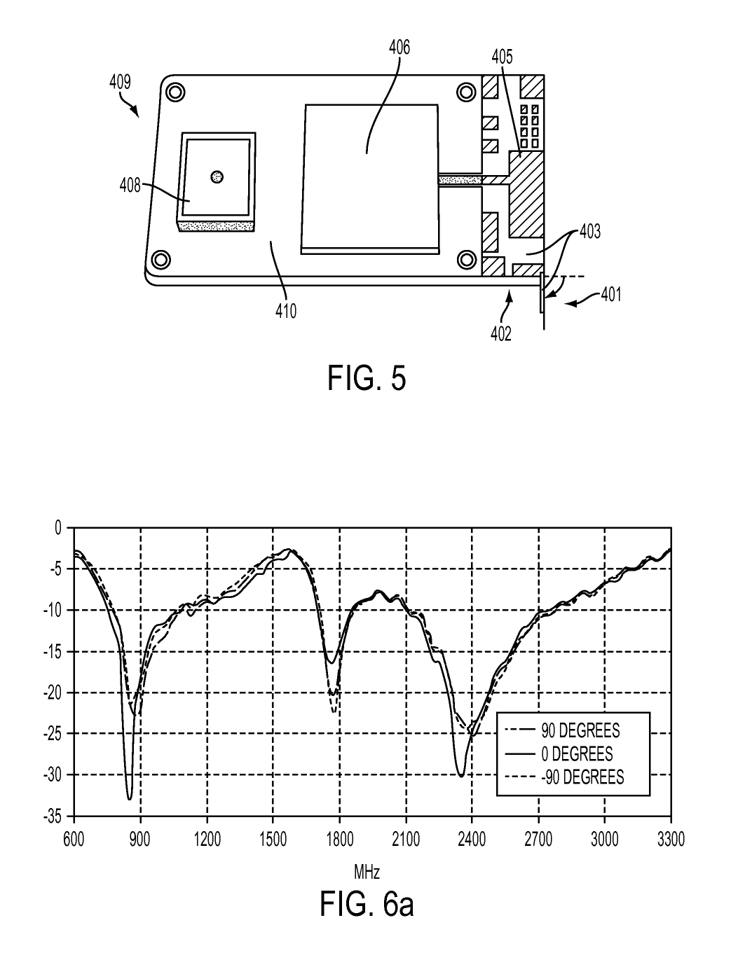

FIGS. 4 and 5 illustrate a typical AVL (automatic vehicle locator device) that incorporates a flexible ultra wide band antenna 400 of the present disclosure. An AVL has a global positioning system integrated circuit (GPS) 418 and a global system for mobile communication (GSM) 406. To achieve best possible isolation and eliminate mutual coupling, its GPS 418 is typically placed as far away from GSM antenna 400 as possible on the board 410. Antenna used for the GSM system in the AVL is the flexible antenna in accordance with a preferred embodiment of the present disclosure while the GPS antenna 418, which can be a ceramic type for such as application.

As is illustrated in FIGS. 4 and 5, the GSM antenna 400 is settled in 0 and −90 degrees configuration relative to the plane of the circuit board 410 respectively. The radiating element, the metal layer 404, of the antenna 400 is essentially in “free space” because it extends beyond the end of the host printed circuit board 410. This configuration results in performance that is not obscured. Such a bend is possible for antenna that requires such physical arrangement to save space or for other mechanical or electromagnetic considerations. A GPS receiver 409 can be provided that is positioned under the circuit board 410 and the GPS antenna 418. As described above, the radiating element of the UWB antenna, the metal layer 404 which may be adhered to the insulation material 403, has a designed spatial geometry for optimized performance in the UWB category of antennas. Spatial geometry of the shape of radiation element 404 has complete control over antenna resonance and performance. Once optimized for a design, change in the form and shape of the metal layer 404 pattern may sometimes be necessary for fine-tuning. In this case, a low cost and flexible antenna 400 can be redesigned and replaced with ease.

### II. OPERATION AND USE OF THE ANTENNAS

The antenna can, but need not, be provided with a flexible cable adapted and configured to connect the antenna to the electronics of the target device, such as a mobile phone. More commonly, the antenna can be configured such that no cable is required to connect the antenna to the target device. For a cable-less antenna, pads are provided on the antenna which provide connections from a module or transmission line via metal contacts or reflow solder.

The antenna can be affixed to a housing of a target device, such as an interior surface of a cell phone housing. Affixing the antenna can be achieved by using suitable double sided adhesive, such as 3M™ Adhesive Transfer Tape 467 MP available from 3M.

As will be appreciated by those skilled in the art, the larger the antenna surface area (or volume), in general the higher the performance in terms of gain and radiation characteristics. Additionally, the gain of the antenna is closely linked to the surface area or volume of the antenna. Thus, the larger the surface area or volume, the higher the gain. In deploying the antenna, clearances can be provided to optimize performance of the antenna. As will be appreciated by those skilled in the art, the larger the clearance, the better the radiation characteristics of the antenna.

### III. METHOD OF MANUFACTURING THE ANTENNAS

The features and functions of the antennas described herein allow for their use in many different manufacturing configurations. For example, in a wireless communication handheld device (e.g. a mobile phone), an antenna can be printed on any suitable substrate including, for example, printed circuit boards (PCB) or flexible printed circuits (FPC). The PCB or FPC is then used to mechanically support and electrically connect the antenna to the electronics of the device deploying the antenna using conductive pathways. tracks or signal traces etched from copper sheets, for example, that has been laminated onto a non-conductive substrate. The printed piece can then be mounted either at the top of the handset backside or at the bottom of the front side of the handset. Thus, antennas 100, 200, 300, 400 according to this disclosure can be manufactured, for example, using a standard low-cost technique for the fabrication of a single-side printed circuit board. Other manufacturing techniques may be used without departing from the scope of the disclosure.

Techniques for manufacturing antennas include determining which materials, processes will be followed. For example, a printed circuit board (PCB), an electrically thin dielectric substrate (e.g., RT/diroid 5880), Flame Retardant 4 (FR-4) material complying with the UL-94-V0, or any suitable non-conductive board can be used as the substrate. A conductive layer is provided from which the antenna will be formed. The conductive layer is generally copper, but other materials can be used without departing from the scope of the disclosure. For example, aluminum, chrome, and other metals or metal alloys can be used.

Data for identifying a configuration for the antenna layer is provided which can then be placed onto an etch resistant film that is placed on the conductive layer which will form the antenna. A traditional process of exposing the conductive layer, and any other areas unprotected by the etch resistant film, to a chemical that removes the unprotected conductive layer, leaving the protected conductive layer in place. As will be appreciated by those skilled in the art, newer processes that use plasma/laser etching instead of chemicals to remove the conductive material, thereby allowing finer line definitions, can be used without departing from the scope of the disclosure.

Multilayer pressing can also be employed which is a process of aligning the conductive material and insulating dielectric material and pressing them under heat to activate an adhesive in the dielectric material to form a solid board material. In some instances, holes can be drilled for plated through applications and a second drilling process can be used for holes that are not to be plated through.

Plating, such as copper plating, can be applied to pads, traces, and drilled through holes that are to be plated through. The antenna boards can then be placed in an electrically charged bath of copper. A second drilling can be performed if required. A protective masking material can then be applied over all or select portions of the bare conductive material. The insulation protects against environmental damage, provides insulation, and protects against shorts. Coating can also be applied, if desired. As a final step, the markings for antenna designations and outlines can be silk-screened onto the antenna. Where multiple antennas are manufactured from a panel of identical antennas, the antennas can be separated by routing. This routing process also allows cutting notches or slots into the antenna if required.

As will be appreciated by those skilled in the art, a quality control process is typically performed at the end of the process which includes, for example, a visual inspection of the antennas. Additionally, the process can include the process of inspecting wall by cross-sectioning or other methods. The antennas can also be checked for continuity or shorted connections by, for example, applying a voltage between various points on the antenna and determining if a current flow occurs. The correct impedance of the antennas at each frequency point can be checked by connecting to a network analyzer.

### IV. KITS

The antennas disclosed herein can be made available as part of a kit. The kit comprises, for example, an antenna comprising an expandable antenna having a conductor supported by a first substrate configurable to expand into a spatial geometry for transmission and reception of a plurality of radio signals and an antenna base having a plurality of first solder pads on a second substrate for physical attachment to a printed circuit board and at least one second solder pad on a second substrate connectable to a terminal of the conductor for connection to an antenna feed point of a radio circuit on the printed circuit board, wherein the first and second substrates are integrally formed along a bending line as a single substrate for the flexible antenna and the first substrate allows it to be bent in a plurality of angles ranging from −90 degrees to +90 degrees relative to the plane of the second substrate for spatial deployment of the antenna conductor. Additionally, the kit may include, for example, suitable mounting material, such as 3M adhesive transfer tape. Other components can be provided in the kit as well to facilitate installation of the antenna in a target device, such as a flexible cable. The kit can be packaged in suitable packaging to allow transport. Additionally, the kit can include multiple antennas, such that antennas and cables are provided as 10 packs, 50 packs, 100 packs, and the like.

### V. EXAMPLES

Monopole Antennas configured according to the disclosure require no ground plane behind of its structure, with complex rectangular elements allocated in a flexible substrate, with a single feeding mechanism. The antenna is SMD process compatible and delivered in tape and reel, making a unique highest performance and practical solution for current market needs. Exemplar antennas configured according to the disclosure use the main board ground plane as its ground plane. A suitable size of the ground plane assists in the antenna efficiency and is related to the wavelength, having more effect at low frequencies. An optimal size for a ground plane is, for example, 62.4×100 mm. However the antenna can be used for smaller ground-planes without departing from the scope of the disclosure. The antenna will use as a ground plane the top and bottom layers rather than the middle ground plane layer. The antenna/ground combination will behave as an asymmetric dipole, the differences in current distribution on the two-dipole arms being responsible for some distortion of the radiation pattern, especially at high frequencies, but keeping omni-directional properties. In use, the antennas are suitable for all mobile and fixed omni-directional cellular applications where internal antennas are required and where it can be placed on the shorter side of the device main-board with enough clearance to radiate efficiently.

RF circuits in mobile devices should be designed for 50 Ohm characteristic impedance at the source (RF module), transmission line (PCB trace or coax cable) and load (antenna). In practice sometimes the characteristic impedance of the circuit is not 50 Ohms at different transmitting and receiving bands. The antenna impedance needs to be changed to match the actual characteristic impedance of the circuit. For a cellular antenna this is most effective when tuning the antenna at the over the air active testing stage in a 3D radiation chamber, when the device is turned on and using the TRP and TIS numbers as guide to find the best impedance match for the antenna.

Bandwidth includes the frequency band below −10 dB return loss working only as octa-band cellular antennas. In general, in small mobile devices, it is more realistic to accept a minimum of −5 dB return loss at band edges for the next targeted application bands in one antenna structure (cellular bands: 700/850/900/1700/1800/1900/2100 and 2600 MHz; WiMAX: 2300 and 2500 MHz; WiFi/Bluetooth: 2400 MHz). A return loss of below −10 dB is targeted for the center of the band. The size of the ground-plane and clearance to metal components define the return loss of the antenna. We recommend as a minimum clearance from metal parts of 10-20 mm, if you go below this in clearance to metal, the return loss is degraded, affecting the antenna and absorbing the energy radiated and/or detuning the antenna. Another antenna parameter used to measure the bandwidth of an antenna is the VSWR, in principle the target is to be below 2:1, where in practice having a multi-band and challenging environments it may go to 3.5:1 at edges and the 2:1 or below is targeted at centre of the band.

The gain of the antenna is closely linked to the effective surface area or volume of the antenna. The larger the surface area or volume of the antenna the higher the gain that can be obtained. The ideal target for gain for a cellular band antenna in a mobile device which needs omni-directional radiation characteristics is peak gain of 0 dBi. Higher gain skews the radiation pattern in some directions and reduces the gain in another area of the pattern. Using thin flexible technology materials can achieve high efficiencies in small form factors and as a consequence high gain maintaining its omni-directional properties. Clearances of 10-20 mm are typically maintained to keep the metal components in the device or metalized substances from interacting which will absorb or reflect the electro-magnetic radiation, substantially reducing the gain. The larger the clearance, the better the radiation characteristics of the antenna. A clearance of 20 mm or more for best gain and radiation efficiency.

Polarization describes the orientation of the wave oscillation. The cellular and broadband antennas configured according to this disclosure are linearly polarized, to most efficiently match with the signals broadcast and the antennas mounted on cellular base-stations. Whether it is horizontally or vertically polarized just depends on how it is mounted when in use. Standing directly in front of the antenna the linear polarization is horizontal if the antenna is placed in a horizontal position and vertical if the antennas are placed in a vertical position. In practice the radiation emitted and received by internal antennas will be to some degree cross-polarized, due to reflections from the environment and scattering in the atmosphere. Most of the cellular antennas are omni-directional, making the antenna orientation relative and therefore sometimes having no effect.

Efficiency of the antenna directly relates to the TRP/TIS results of a device in OTA testing if the module has 50 Ohm impedance. However it is only one factor and care must be taken to not single out antenna efficiency as the only reason why a device does not meet certain TRP/TIS targets. Impedance mismatches, conducted power from the module and noise can sometimes have a larger effect on TRP/TIS than the antenna efficiency itself.

In general for a monopole, the required PCB ground plane length should be at least one quarter (λ/4) wavelength of the lowest operating band. If the ground plane is much smaller than λ/4 of the lower bands, will affect the efficiency of the antenna, this mean the having problem to radiate the energy. If the ground plane is much longer than λ/4 of the lower bands, will affect the high frequency, this is easily observed in the efficiency graph provided for different ground plane lengths as next. For those devices where the length of the ground plane is larger than the optimal (100 mm), can be compensated increasing the width of the ground plane. There is no specific proportion to do this.

An antenna configured as shown in FIG. 1 was tested had a radiating element with spatial geometry as shown. The full spectrum reflection coefficient of the antenna is shown in terms of signal magnitude. It is clearly observable that the antenna has three resonances, one at the lower frequency and two at higher frequencies. The antenna was configured to have selected approximated dimensions (as shown in FIG. 2c):

TABLE 1
EXEMPLAR DIMENSION

| Area | Width (mm) |
|---|---|
| A | 5.3 |
| B | 3.5 |
| C | 2.0 |
| D | 3.5 |
| E | 2.0 |
| F | 3.5 |
| G | 2.0 |
| H | 3.5 |
| I | 2.0 |
| J | 3.0 |
| K | 22.4 |
| L | 3.0 |
| N | 7.3 |
| O | 2.0 |
| P | 7.0 |
| Q | 7.0 |
| R | 5.2 |
| S | 7.0 |
| T | 3.0 |
| U, U′ | 0.5 |
| 1 | 5.3 |
| 2 | 1.3 |
| 3 | 2.0 |
| 4 | 2.0 |
| 5 | 4.2 |
| 6 | 4.0 |
| 7 | 4.0 |
| 8 | 4.0 |

As will be appreciated by those skilled in the art, the dimensions can be increased or decreased proportionally so that the overall size of the antenna base ranges from 50 mm to 80 mm in width, 10 mm to 20 mm in length, and about 3 mm to about 15 mm in height.

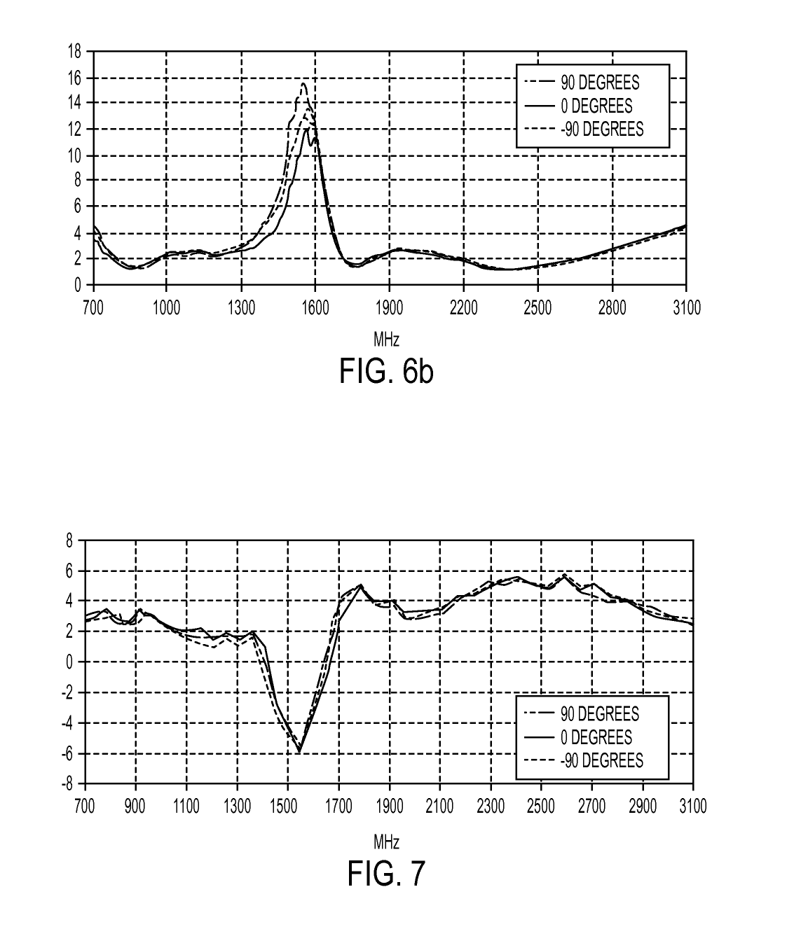

FIG. 6a shows the return loss characteristic of an antenna of the present disclosure over a range of 600 MHz to 3300 MHz where the antenna expand is positioned at 90 degrees, 0 degrees and −90 degrees. The antenna measured in FIG. 1 was tested on an evaluation circuit board, with its radiating portion positioned in three different angles (boundary conditions). The test results show that angling places no effect on the antenna performance, proving the feasibility of the antenna of the present disclosure in applications of differently angled positions vs. return loss (y-axis).

FIG. 6b shows the VSWR data of an antenna of the present disclosure over a range of 700 MHz to 3100 MHz where the antenna expand is positioned at 90 degrees, 0 degrees and −90 degrees. Typical bandwidth definition calls for a return loss of below −5 dB (equivalent to a VSWR of 3.5). Such return loss reflects how much power is transferred from the radio circuitry to the antenna. Low end of the antenna frequency bandwidth is approximately in the range of from 700 to 1400 MHz, and the percentage of the bandwidth at this lower frequency is 70%, the lower frequency at 850 MHz. On the other hand, for the high end of the bandwidth, the frequency is from roughly 1675 to 3100 MHz, and the percentage of the bandwidth at the higher frequency is 60%, the higher frequency at 1900 MHz. The percent of bandwidth for the whole antenna spectrum based in the 3 resonances and below −5 dB is 86% from 700 to 3100 MHz, where the y-axis is the VSWR.

The wider bandwidth the antennas of the present disclosure are capable of covering all frequencies for present-day communication technologies that include the cellular and ISM bands such as 700, 850, 900, 1700, 1800, 1900, 2100, 2400 and 2500 MHz and other frequencies that can be used in up-coming technologies in the antenna spectrum from 700 to 1400 MHz and 1675 to 3100 MHz. In other words, the antenna of the present disclosure has the right characteristic for an ultra wide band antenna, with a total bandwidth of 86%.

FIG. 7 shows the gain characteristic measured in dBi of an antenna of the present disclosure that is at maximum angles in three dimensional test scanning The antenna was tested in three different positions of the first substrate in −90, 0 and +90 degrees in an echoic chamber equipped with a 3D scan system. The antenna tested exhibits high correlation among its three different positions. The gain at lower frequencies varies from 1.8 to 3.8 dBi for the three positions and the gain at the higher frequencies is from 2.5 to 6 dBi. As can be seen from the gain characteristic curve, the antenna performed extremely well. The antenna exhibits high performance along the whole antenna spectrum.

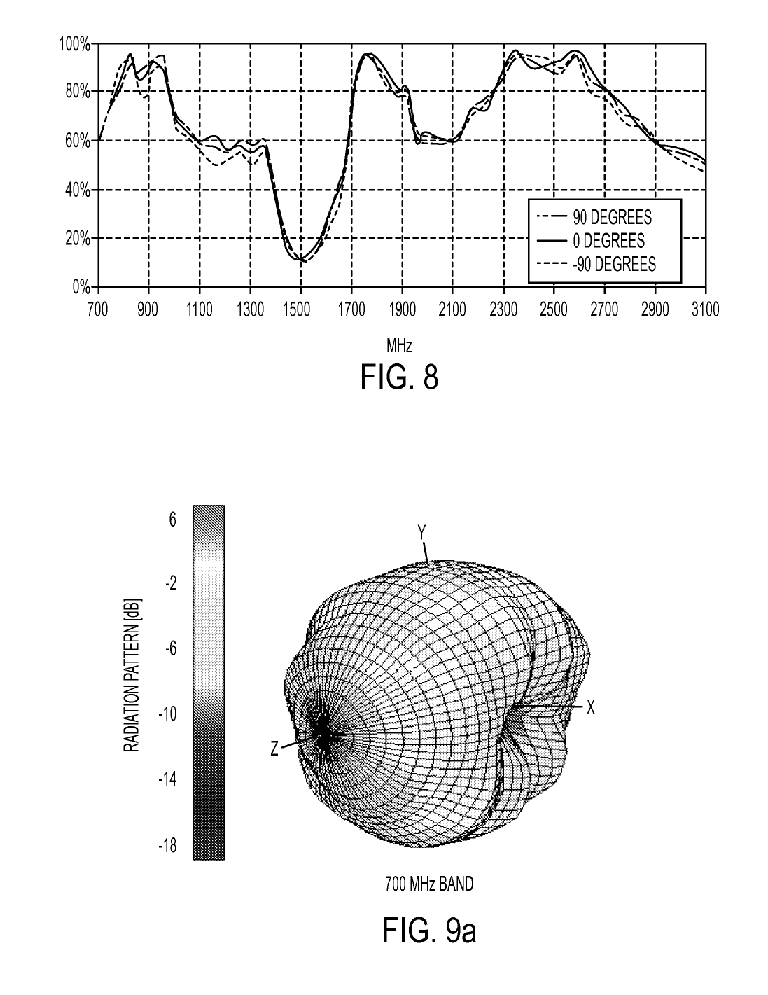

One of the most important parameters to qualify an antenna performance is the efficiency. The efficiency characteristic shown in FIG. 8 is relates to how much energy can be conveyed from antenna to free space. In other words, this efficiency represents the real energy conversion performance of an antenna measured in percentage. The antenna tested exhibits high percentage value across its entire operating spectrum. For the cellular bands the efficiency is above 60% across the entire bandwidth. 50% efficiency means that half of the electrical power delivered from the radio circuitry is radiated into the space as signal. For the main 850 and 1900 MHz cellular bands in the United States, the antenna tested achieved over 80% efficiency.

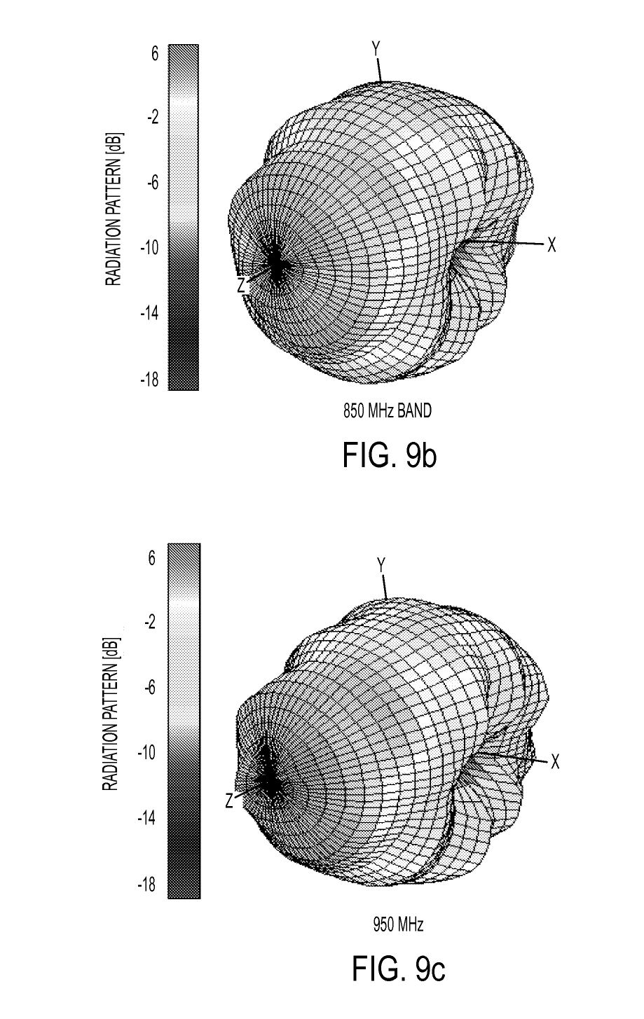

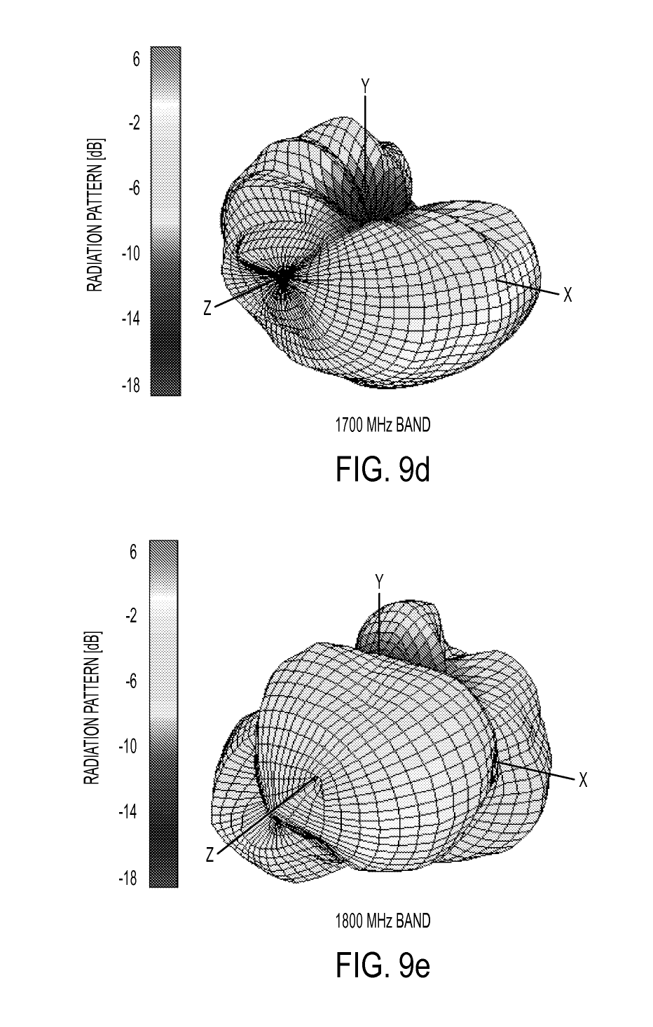

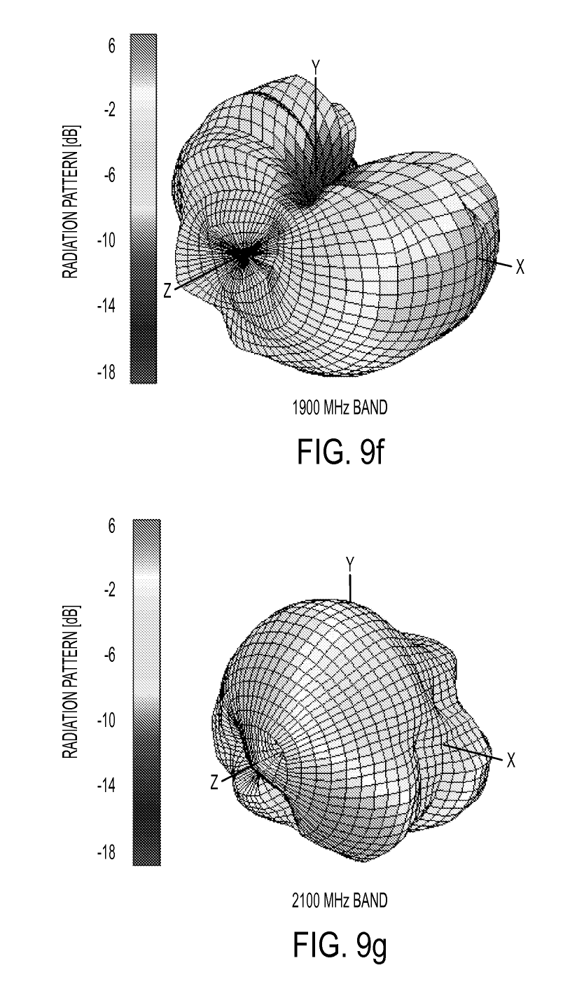

For radiation pattern only three representative frequencies at 700, 850, 950, 1700, 1800, 1900 and 2100 MHz were selected and tested on prototype antenna, the test results as described above reveal the fact that the antenna of the present disclosure has omni-directional properties. For example, the 700, 850, 950 MHz radiation pattern shown in FIG. 9a-c exhibits an almost perfect characteristic for an omni-directional antenna. FIGS. 9d-g show the radiation pattern of an antenna of the present disclosure tested at 1700 MHz, 1800 MHz, 1900 MHz, and 2100 MHz respectively. In these tested cases the radiation pattern each presents an omni-directional characteristic that is a little asymmetric as consequence of higher frequencies.

In summary, the low profile flexible antenna in accordance with the present disclosure based essentially on the proven flexible circuit technology is particularly useful in small size antenna applications such as for consumer electronic devices. Cell phones, PDA and other consumer electronics equipped with such an innovative flexible antenna of the present disclosure can enjoy very good antenna efficiency in tests conducted on prototypes, antenna efficiencies of more than 50% for all bands have been observed.

In a monopole application, the flexible antenna of the present disclosure can be coupled to the ground plane of the main board to have improved radiation characteristics. This leads to improved device performance in areas of signal strength, sensitivity, data throughput and reliability. The surface mountable flexible antenna of the present disclosure is therefore a low cost yet good performance alternative to existing antenna technologies, which require a costly cable and connector.

The surface mountable flexible antenna of the present disclosure can be designed to work in one band or multiple bands across a range of frequencies. It can be used in all radio frequency applications in cellular, ISM bands and others.

An antenna built according to the above disclosure typically has the following characteristics:

TABLE 2
ANTENNA CHARACTERISTICS

| Parameter | Octa Bands | | | | | | | |
|---|---|---|---|---|---|---|---|---|
| Band (MHz) | 700 | 850 | 900 | 1700 | 1800 | 1900 | 2100 | 2600 |
| Return Loss | −9 | −18 | −20 | −10 | −13 | −8 | −8 | −8 |
| (dB) | | | | | | | | |
| Efficiency | 70 | 95 | 95 | 80 | 95 | 80 | 65 | 60 |
| (%) | | | | | | | | |

| | |
|---|---|
| Impedance | 50 Ohms |
| VSWR | ≦2:1 |
| Polarization | Linear |
| Power Handled | 5 W |
| (Watts) | |
| Operation | −40 degrees~+85 degrees |
| Temperature | |
| (Celsius) | |
| Storage | −40 degrees~+85 degrees |
| Temperature | |
| (Celsius) | |
| Dimensions | 62.4 ×. 14.2 × 10.8 (folded) |
| (mm) | |
| Weight (mg) | 400 |
| SMD | Compatible |
| RoHS | YES |
| Compliant | |

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A flexible antenna for an electronic device comprising:
an expandable antenna having an antenna conductor supported by an expandable antenna substrate configurable to expand into a spatial geometry for transmission and reception of signals; and
an antenna base having a plurality of first solder pads on an antenna base substrate for physical attachment to a printed circuit board, a second solder pad electrically connected to a terminal of the antenna conductor for connection to an antenna feed point of a radio circuit on the printed circuit board, and one or more apertures positioned along at least a portion of a perimeter of the second solder pad; wherein the expandable antenna substrate and antenna base substrates are positioned in a first plane and a second plane positioned at one or more angles from −90 to +90 degrees from the first plane.

2. The flexible antenna of claim 1, further comprising a stiffening plate adhered to the antenna base substrate on a surface opposite the first plurality of solder pads.

3. The flexible antenna of claim 2 wherein the stiffening plate is a removable stiffening plate.

4. The flexible antenna of claim 1 wherein the antenna conductor comprises a copper layer adhered to the surface of the expandable antenna substrate.

5. The flexible antenna of claim 1 wherein the substrate is a polyimide film.

6. The flexible antenna of claim 1 wherein the antenna provides for at least eight separate cellular bands and up to nine cellular bands wherein the antenna further is adapted and configured to operate in at least 700, 850, 900, 1700, 1800, 1900, 2100 and 2600 MHz and the antenna further incorporates three more bands at 2300, 2400 and 2500 MHz, in the ISM bands on the flexible antenna; and sufficient performance in ultra wide band antenna frequencies from 100 MHz to 18 GHz with high antenna parameters.

7. The flexible antenna of claim 1 further comprising a configuration control component.

8. A method of assembling a flexible antenna to a printed circuit board comprising the step of surface mounting an antenna base substrate onto a printed circuit board.

9. A planar antenna manufactured by patterning a substrate comprising a dielectric layer, and a conductive layer applied to at least one surface of the substrate, comprising:
a conductive layer attached to a first surface of the substrate wherein the conductive layer further comprises an expandable antenna having an antenna conductor supported by an expandable antenna substrate configurable to expand into a spatial geometry for transmission and reception of radio signals; and an antenna base having a plurality of first solder pads on an antenna base substrate for physical attachment to a printed circuit board, a second solder pad electrically connected to a terminal of the antenna conductor for connection to an antenna feed point of a radio circuit on the printed circuit board, and one or more apertures positioned along at least a portion of a perimeter of the second solder pad; wherein the expandable antenna substrate and antenna base substrates are positioned in a first plane and a second plane positioned at one or more angles from −90 to +90 degrees from the first plane.

10. The antenna manufactured by patterning a substrate of claim 9 wherein each of the antenna section and the ground section is a layer of patterned foil adhered to the first surface of the substrate.

11. The antenna manufactured by patterning a substrate of claim 9 wherein the substrate is at least one of a Flame Retardant 4 material, a flexible printed circuit substrate, and a single-side printed circuit board substrate.

12. The antenna manufactured by patterning a substrate of claim 9 wherein the conductive layer is selected from the group comprising copper, aluminum, nickel, silver, and chrome.

13. The antenna manufactured by patterning a substrate of claim 9 further comprising an insulation layer on top of the conductive layer.

14. The antenna manufactured by patterning a substrate of claim 9 further comprising a configuration control component.

15. An antenna kit comprising:
an antenna comprising a conductive layer attached to a first surface of the substrate wherein the conductive layer further comprises an expandable antenna having an antenna conductor supported by an expandable antenna substrate configurable to expand into a spatial geometry for transmission and reception of radio signals; and an antenna base having a plurality of first solder pads on an antenna base substrate for physical attachment to a printed circuit board, a second solder pad electrically connected to a terminal of the antenna conductor for connection to an antenna feed point of a radio circuit on the printed circuit board, and one or more apertures positioned along at least a portion of a perimeter of the second solder pad; wherein the expandable antenna substrate and antenna base substrates are positioned in a first plane and a second plane positioned at one or more angles from −90 to +90 degrees from the first plane.

16. The kit of claim 15 further comprising one or more antennas.

17. The kit of claim 15 further comprising a flexible cable adaptable to connect the antenna to a target device.

18. The kit of claim 15 further comprising a planar antenna mounting material.

19. The kit of claim 15 further comprising a package adapted and configured to house one or more antennas.
